(19) United States
(12) Patent Application Publication
(10) Pub. No.: US 2016/0010500 A1
(43) Pub. Date: Jan. 14, 2016

(54) SUPERCHARGING DEVICE

(71) Applicant: Bosch Mahle Turbo Systems GmbH & Co. KG, Stuttgart (DE)

(72) Inventors: Ruediger Kleinschmidt, Besigheim (DE); Ulrich Siol, Stuttgart (DE); Alexander Baeuerle, Stuttgart (DE); Thomas Striedelmeyer, Stuttgart (DE); Joerg Eckert, Winnenden (DE); Christoph Butscher, Leonberg (DE)

(21) Appl. No.: 14/794,771

(22) Filed: Jul. 8, 2015

(30) Foreign Application Priority Data
Jul. 9, 2014 (DE) 102014213330.0

(51) Int. Cl. F01D 25/18; F01D 25/16; F01D 5/02; F16C 17/02; F16C 33/10

(52) U.S. Cl. CPC F01D 25/183; F16C 17/028; F16C 33/1065; F01D 5/02; F01D 25/162; F05D 2220/40; F05D 2260/98; F05D 2240/50; F02B 37/00

(57) ABSTRACT

A supercharging device may include a rotor mounted in a bearing housing via at least one bearing bush. The bearing bush may include an oil bore. An oil film may be disposed at least one of between the rotor and the bearing bush and between the bearing bush and the bearing housing. The bearing housing may include at least one oil feed duct for lubricating the bearing bush. At least one of the oil feed duct and the oil bore may be configured with respect to the bearing bush such that the bearing bush during the operation of the supercharging device is positively accelerated in a direction of rotation of the rotor via an oil jet communicated from the oil feed duct.

### CROSS-REFERENCE TO RELATED APPLICATIONS

This application claims priority to German Patent Application Number 10 2014 213 330.0 filed on Jul. 9, 2014, the contents of which are hereby incorporated by reference in their entirety.

### TECHNICAL FIELD

The present invention relates to a supercharging device, in particular an exhaust gas turbocharger with a rotor, which via at least one bearing bush comprising an oil bore is mounted in a bearing housing. The invention additionally relates to a bearing bush for mounting a rotor in such a supercharging device.

### BACKGROUND

Usually, rotors in supercharging devices are floatingly mounted by means of so-called bearing bushes, wherein the bearing bush surrounds the shaft of the rotor to be mounted and is mounted in a bearing housing. The bearing bush has an outer and an inner surface via which with given shearing forces between outer and inner oil film a bush rotational speed materialises. When mounting the rotor it must be observed that in the space between the inner surface of the bearing bush and the shaft because of the rotation of the rotor shaft vibration of the rotor shaft can be caused because of oil whirl through dynamic action of the oil film. Such whirl vibration however impairs the mounting and should therefore be avoided.

From U.S. Pat. No. 3,096,126 A an exhaust gas turbocharger with a rotor is known, which is mounted in a bearing housing and in the case of which the previously described whirl vibrations of the rotor shaft because of the oil film are to be suppressed. To this end, the bearing bush is braked by the friction resistance of the same being increased.

In order to communicatingly connect the annular space that is present between the bearing housing and the outer surface of the bearing bush with the annular space that is present between the rotor shaft and the inner surface of the bearing bush, known bearing bushes usually comprise an oil bore which substantially runs radially through the bearing bush and makes possible oil transport between the two previously mentioned annular spaces.

### SUMMARY

The present invention deals with the problem of stating an improved or at least an alternative embodiment for a supercharging device of the generic type by means of which in particular negative whirl vibrations in the region of an oil film can be at least reduced.

According to the invention, this problem is solved through the subjects of the independent claims. Advantageous embodiments are subject of the dependent claims.

The present invention is based on the general idea of increasing a rotational speed of a bearing bush of a radial bearing for a rotor in a supercharging device through targeted acceleration of the bearing bush so far that the oil whirl occurs only at frequencies, i.e. at rotor rotational speeds which are outside the normal operating range, so that the oil whirl can be entirely avoided for the normal operating state of the supercharging device. The supercharging device according to the invention in this case comprises a rotor which is mounted in a bearing housing via at least one bearing bush comprising an oil bore. Between the rotor and the bearing bush on the one hand and the bearing bush and the bearing housing on the other hand an annular space with an oil film each for radially mounting the rotor is provided. According to the invention, the bearing housing now comprises at least one oil feed duct for lubricating the bearing bush, wherein the oil feed duct and/or the oil bore in the bearing bush are orientated or designed in such a manner that the bearing bush during the operation of the supercharging device is positively accelerated in the direction of rotation of the rotor by an oil jet issuing from the oil feed duct. In contrast with U.S. Pat. No. 3,096,126 A the bearing bush is thus not braked but accelerated namely with such intensity that any oil whirl that may occur would occur only at a rotor rotational speed which is not reached during the operation of the supercharging device, i.e. in particular of the exhaust gas turbocharger. With this comparatively simple modification a significantly improved mounting of the rotor can thus be achieved.

With an advantageous further development of the solution according to the invention, the bearing bush comprises at least one keyway which is located on the outside and runs in axial direction and is open at the face end and towards the outside, which the oil jet issuing from the oil feed duct enters and because of this brings about the acceleration of the bearing bush. Here, the acceleration of the bearing bush takes place pulse-like whenever the bearing bush has rotated further so far that the oil jet again enters the same keyway or an adjacent keyway. Alternatively to this embodiment, the bearing bush can also comprise at least one keyway that is located outside and runs in axial direction and is closed at the face end, which in addition is designed arc-shaped for example. An angular design of the keyway is also conceivable. Even this listing which is not conclusive suggests the great variety with which the keyway in the region of the outer cylindrical surface of the bearing bush can be designed in order to achieve the rotational speed increase according to the invention.

Practically, the at least one oil bore runs radially or obliquely through the bearing bush. Upon a radial course of the oil bore through the bearing bush the keyway described in the previous paragraph is required for accelerating the same whereas with an oblique course the keyway can purely theoretically be even omitted since because of the oblique arrangement of the oil bore the oil stream transported within the same creates a propulsion effect which accelerates the bearing bush in the direction of rotation of the rotor. Obviously, the provision both of at least one keyway as well as an oblique oil bore is purely theoretically also conceivable.

In a further advantageous embodiment of the solution according to the invention, the at least one oil feed duct comprises a nozzle acting in the direction of the bearing bush. Such a nozzle brings about accelerating the oil jet issuing from the oil feed duct as a result of which the same impinges on the bearing bush with a higher velocity thereby accelerating the same even more. Obviously, purely theoretically, multiple oil feed ducts can also be arranged in the previously described manner in the bearing housing offset in circumferential direction and/or offset in axial direction.

The present invention furthermore is based on the general idea of designing a bearing bush for mounting a rotor in a supercharging device with at least one keyway that is located on the outside and runs in axial direction and is open on the face end and towards the outside as a result of which the same upon a corresponding oil inflow out of the oil feed duct is accelerated in the direction of rotation of the rotor. Alternatively, the bearing bush can obviously comprise also a keyway that is located outside and runs in axial direction and is closed on the face end but open towards the outside or an arc-shaped keyway that is open on the face end and towards the outside or a keyway that is located outside and angular and open on the face end and towards the outside. If the oil feed duct in the bearing housing is correspondingly orientated so that the oil jet issuing from the same impinges on the outer circumferential surface of the bearing bush substantially tangentially in the direction of rotation of the same, in which such a supercharging device can also be retrofitted with a new bearing bush according to the invention and thereby improved with respect to its mounting. If by contrast the oil feed duct runs radially to the bearing bush the rotational speed-increasing effect could be achieved through an oil bore running obliquely through the bearing bush so that also in this case a conventional exhaust gas turbocharger, i.e. a conventional supercharging device, can be improved with respect to its oil whirl by installing a new bearing bush according to the invention.

Further important features and advantages of the invention are obtained from the subclaims, from the drawings and from the associated figure description with the help of the drawings.

It is to be understood that the features mentioned above and still to be explained in the following cannot only be used in the respective combination stated but also in other combinations or by themselves without leaving the scope of the present invention.

Preferred exemplary embodiments of the invention are shown in the drawings and are explained in more detail in the following description, wherein same reference characters relate to same or similar or functionally same components.

### BRIEF DESCRIPTION OF THE DRAWINGS

Here it shows, in each case schematically

FIG. 1 a sectional representation through a supercharging device according to the invention in the region of a bearing bush and a view from the outside of the bearing bush according to the invention,

FIGS. 2 and 3 representations as in FIG. 1, however with differently designed bearing bush,

FIG. 4 further views of different bearing bushes,

FIG. 5 a representation as in FIG. 1, however with differently directed oil feed duct and differently directed oil bore in the bearing bush,

FIG. 6 a representation as in FIG. 1, however with differently designed bearing bush and differently designed oil feed ducts, in this case with nozzle.

### DETAILED DESCRIPTION

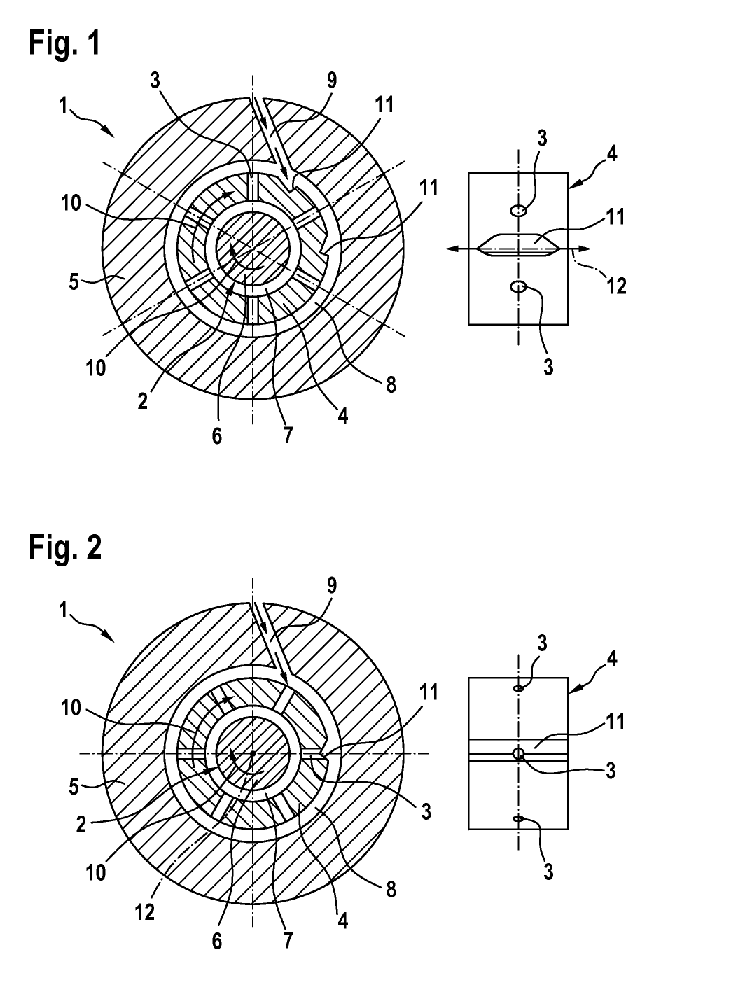

According to the FIGS. 1 to 3 and 5 and 6, a supercharging device 1 according to the invention, which for example can be designed as an exhaust gas turbocharger, comprises a rotor 2, which via at least one bearing bush 4 comprising an oil bore 3 is mounted in a bearing housing 5 of the supercharging device 1. Between the rotor 2, i.e. in the concrete case a shaft 6 of the rotor 2, and the bearing bush 4, a first annular space 7 is provided, in which an oil film is present, just as in a second annular space 8, which is bounded by the bearing housing 5 and the bearing bush 4. For lubricating the two annular spaces 7, 8 an oil feed duct 9 is provided in the bearing housing 5 according to the invention, wherein the oil feed duct 9 and/or the oil bore 3 in the bearing bush 4 is/are orientated and/or designed in such a manner that the bearing bush 4 during the operation of the supercharging device 1 is positively accelerated in the direction of rotation 10 of the rotor 2 or of the shaft 6 by an oil jet issuing from the oil feed duct 9. Because of this, targeted acceleration of the bearing bush 4 can be achieved in such a manner that the so-called oil whirl occurs only at frequencies (i.e. at rotor rotational speeds) that are outside the normal operating range.

Considering now the bearing bush 4 according to FIG. 1, it is evident on the same that it comprises multiple oil bores 3, in the present case even a total of six, and two keyways 11 which are located outside, which run in axial direction and are closed at the face end but open towards the outside, which is entered by an oil jet issuing from the oil feed duct 9 and the bearing bush 4 is accelerated in the direction of rotation 10 because of this. Obviously, multiple such keyways 11 or merely a single one can also be provided. Usually, at least two such keyways 11 are arranged about the circumference of the bearing bush 4 in order to positively influence the bearing bush 4 with respect to its unbalance.

Considering the keyway 11 of the bearing bush 4 shown in FIG. 2, it is evident that the same runs in axial direction 12 but is designed open at the face end. This means the keyway 11 extends over the entire axial length of the bearing bush 4.

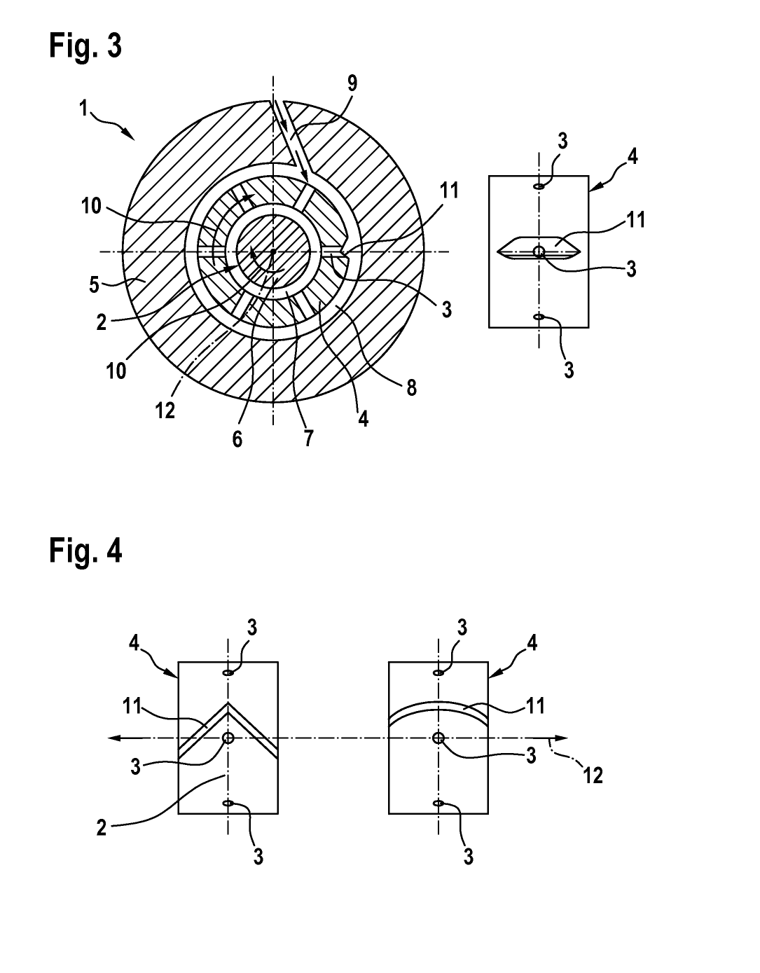

Considering the keyway 11 of the bearing bush 4 of FIG. 3 the same is designed analogously to the keyway 11 according to FIG. 1, while in this case the oil bore 3 opens into the keyway 11, just as according to FIG. 2, however in contrast with the embodiments according to the FIGS. 1 and 4, in the case of which the keyways 11 in each case are arranged in circumferential direction between two oil bores 3.

In the case of the keyways 11 of the bearing bushes 4 shown in the FIGS. 4 the keyway 11 in the left representation is designed angled, whereas in the right representation it is designed arc-shaped.

A particularity of the oil feed duct 9 is additionally shown according to FIG. 6, in which the oil feed duct 9 comprises a nozzle 13 acting in the direction of the bearing bush 4, in particular in direction of rotation 10 of the bearing bush 4. Here, the nozzle 13 brings about acceleration of the oil stream flowing in the oil feed duct 9.

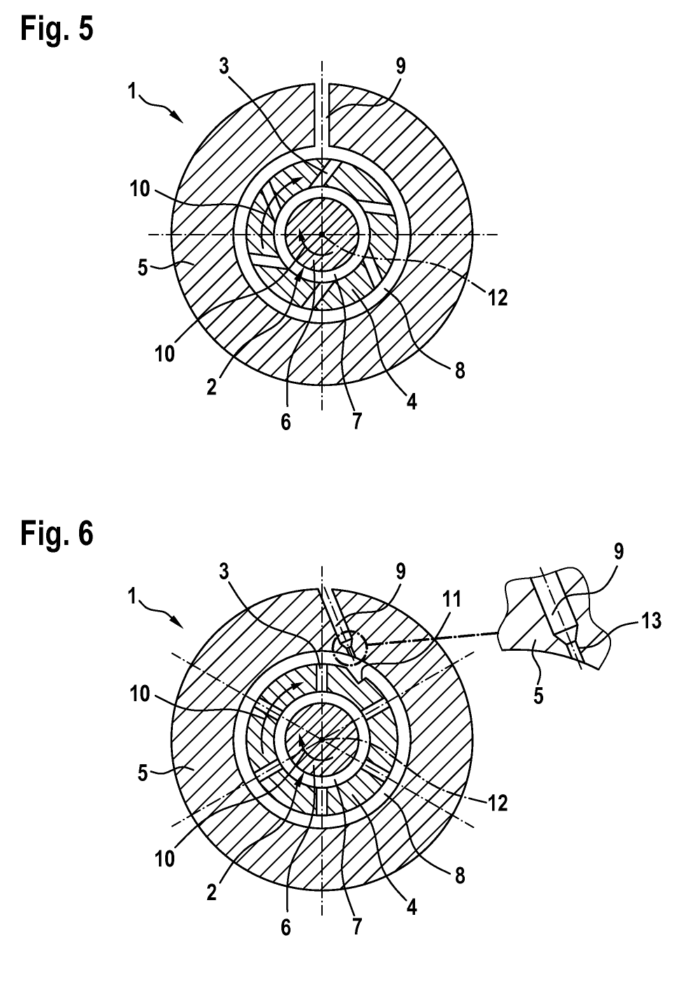

Considering the oil feed ducts 9 according to the FIGS. 1 to 3 and 6, it is evident that the oil feed ducts 9 shown there run obliquely to the axial direction 12, whereas the oil feed duct 9 according to FIG. 5 runs orthogonally to the axial direction 12. In the case shown according to FIG. 5 the oil bore 3 by contrast however runs obliquely to the axial direction 12, which in this case runs perpendicularly to the image plane. The bore 3 functions as a nozzle, the acceleration of the oil in the bore 3 imparting a rotary impulse (in clockwise direction in FIG. 5) to the bush 4.

All shown embodiments in this case have in common that by orientating or designing the oil feed duct 9 and/or the oil bore 3 the bearing bush 4 during the operation of the supercharging device 1, i.e. in particular during the operation of the exhaust gas turbocharger, is positively accelerated in the direction of rotation 10 of the rotor 2 by an oil jet issuing from the oil feed duct 9, as a result of which the critical oil whirl occurs only at frequencies (rotor rotational speeds) which are outside the normal operating range.

1. A supercharging device, comprising:
a rotor mounted in a bearing housing via at least one bearing bush, the bearing bush including an oil bore, and an oil film disposed at least one of between the rotor and the bearing bush and between the bearing bush and the bearing housing,
wherein the bearing housing includes at least one oil feed duct for lubricating the bearing bush, and
at least one of the oil feed duct and the oil bore are configured with respect to the bearing bush such that the bearing bush during the operation of the supercharging device is positively accelerated in a direction of rotation of the rotor via an oil jet communicated from the oil feed duct.

2. The supercharging device according to claim 1, wherein at least one of:
the bearing bush further includes at least one keyway disposed on an outer surface and extends in an axial direction of the rotor, and wherein the at least one keyway is open at axial face ends and is open radially towards the bearing housing,
the bearing bush further includes at least one keyway disposed on an outer surface and extends in an axial direction of the rotor, and wherein the at least one keyway is closed at axial face ends and is open radially towards the bearing housing,
the bearing bush further includes at least one keyway disposed on an outer surface and extends arc-shaped in an axial direction of the rotor, and wherein the at least one keyway is open at axial face ends and is open radially towards the bearing housing, and
the bearing bush further includes at least one keyway disposed on an outer surface and extends at an angle in an axial direction of the rotor, and wherein the at least one keyway is open at axial face ends and is open radially towards the bearing housing.

3. The supercharging device according to claim 1, wherein the bearing bush includes at least two oil bores and at least one keyway disposed between the at least two oil bores.

4. The supercharging device according to claim 2, wherein the at least one oil bore opens into the at least one keyway.

5. The supercharging device according to claim 1, wherein the at least one oil bore extends at least one of radially and obliquely through the bearing bush.

6. The supercharging device according to claim 1, wherein the at least one oil feed duct extends obliquely to an outer surface of the bearing bush.

7. The supercharging device according to claim 1, wherein the at least one oil feed duct includes a nozzle extending in a direction of the bearing bush.

8. A bearing bush for mounting a rotor of a supercharging device comprising:
an inner surface radially spaced from an outer surface and at least one oil bore extending from the inner surface to the outer surface, the outer surface including at least one keyway extending in an axial direction, wherein at least one of:
the keyway is open at axial face ends and is open radially towards the outside,
the keyway is closed at axial face ends and is open radially towards the outside,
the keyway is arc-shaped and open at axial face ends and open radially towards the outside, and
the keyway is angular and open at axial face ends and open radially towards the outside;
and wherein the oil bore is configured to receive an oil jet and positively accelerate the bearing bush in a direction of rotation of the rotor during the operation of the supercharging device.

9. The bearing bush according to claim 8, further comprising at least two oil bores extending between the inner surface and the outer surface, wherein the at least one keyway disposed between the at least two oil bores.

10. The bearing bush according to claim 8, wherein the at least one oil bore opens into the at least one keyway.

11. The bearing bush according to claim 8, wherein the at least one oil bore extends at least one of radially and obliquely between the inner surface and the outer surface.

12. The bearing bush according to claim 8, wherein a plurality of keyways are distributed circumferentially about the outer surface.

13. The supercharging device according to claim 1, wherein the bearing bush further includes at least one key disposed on an outer surface facing the bearing housing, and wherein the at least one keyway extends along the outer surface in an axial direction of the rotor.

14. The supercharging device according to claim 13, wherein the at least one keyway extends entirely over an axial length of the outer surface, the at least one keyway being open at axial face ends and open radially towards the bearing housing.

15. The supercharging device according to claim 13, wherein the at least one keyway extends partially over an axial length of the outer surface, the at least one keyway being closed at axial face ends and open radially towards the bearing housing.

16. The supercharging device according to claim 13, wherein the at least one keyway extends entirely over an axial length of the outer surface and defines at least one of an arc-shaped contour and an angled contour, the at least one keyway being open at axial face ends and open radially towards the bearing housing.

17. The supercharging device according to claim 13, wherein the bearing bush includes at least two oil bores circumferentially spaced from one another, and wherein the at least one keyway is disposed between the at least two oil bores.

18. The supercharging device according to claim 13, wherein the at least one oil bore opens into the at least one keyway.

19. The supercharging device according to claim 4, wherein the at least one oil bore extends at least one of radially and obliquely through the bearing bush.

20. An exhaust gas turbocharger, comprising:
a rotor mounted in a bearing housing via at least one bearing bush, wherein a first annular space is disposed between the rotor and the bearing bush and a second annular space is disposed between the bearing bush and the bearing housing;
at least one oil bore disposed in the bearing bush and fluidly connecting the first annular space with the second annular space;
at least one keyway disposed on an outer surface of the bearing bush facing the bearing housing, the at least one keyway extending along the outer surface in an axial direction and being opening radially towards the bearing housing; and
at least one oil feed duct disposed in the bearing housing for lubricating the bearing bush;
wherein the oil feed duct and the at least one oil bore extend obliquely with respect to each other and wherein the bearing bush is positively accelerated in a direction of rotation of the rotor via an oil jet communicated from the at least one oil feed duct during the operation of the exhaust gas turbocharger.
